(19) United States
(12) Patent Application Publication
(10) Pub. No.: US 2025/0379986 A1
(43) Pub. Date: Dec. 11, 2025

(54) TEMPLATE-BASED INTRA MODE DERIVATION MERGE MODE IMPROVEMENTS

(71) Applicant: Nokia Technologies Oy, Espoo (FI)

(72) Inventors: Döne BUGDAYCI SANSLI, Tampere (FI); Saverio BLASI, London (GB)

(21) Appl. No.: 19/223,598

(22) Filed: May 30, 2025

Related U.S. Application Data
(60) Provisional application No. 63/656,458, filed on Jun. 5, 2024.

(51) Int. Cl. H04N 19/159; H04N 19/105; H04N 19/119; H04N 19/176; H04N 19/593

(52) U.S. Cl. CPC H04N 19/159; H04N 19/105; H04N 19/119; H04N 19/176; H04N 19/593

(57) ABSTRACT

Multiple techniques are presented for template-based intra mode derivation merge mode improvements. Three main examples are outlined: (I) Recomputing blending weights of TIMD merge candidates; (II) Using block vectors from neighboring blocks to replace one or more TIMD Merge predictors; and (III) Partitioning a template into sub-templates.

### TECHNICAL FIELD

Examples of embodiments herein relate generally to video encoding and decoding and, more specifically, relate to intra-prediction modes specifically using templates.

### BACKGROUND

In the context of video compression, an Intra Prediction (IP) mode refers to the way the encoder/decoder predicts the value of a pixel or block using information extracted from within the same frame (intra-frame). This is different from inter-frame prediction, where the value of a pixel is predicted based on values from other frames.

In a block such as Coding Unit (CU), intra prediction modes are used to predict the values of pixels within the CU. A CU is typically a rectangular region, e.g., of 4×4, 8×8, or 16×16 pixels, which is the basic unit of processing in video compression. In more detail, a CU is a coding block of luma samples, two corresponding coding blocks of chroma samples of a picture that has three sample arrays, or a coding block of samples of a monochrome picture or a picture that is coded using three separate color planes and syntax structures used to code the samples.

There are several types of Intra Prediction modes, including:
1. DC prediction: The predicted value is the average of all pixel values within the CU.
2. Planar prediction: The predicted value is a single value that is repeated for all pixels within the CU.
3. Vertical prediction: The predicted value is derived from the neighboring pixels in the vertical direction.
4. Horizontal prediction: The predicted value is derived from the neighboring pixels in the horizontal direction.
5. Skew prediction: The predicted value is derived from the neighboring pixels at an angle (skew) relative to the horizontal or vertical direction.

When using template-based most-probable modes (MPMs), a set of predefined templates are typically used that capture various patterns and shapes found in natural images. These templates are then matched against the block of pixels to determine the most probable mode.

The intra prediction modes used in this context include the following (in addition to a DC) mode:

Planar-H: predicts each pixel as the average of its left and top neighbors.

Planar-V: predicts each pixel as the average of its above and right neighbors.

Horizontal: predicts each pixel as a linear combination of its left and current neighbors.

Vertical: predicts each pixel as a linear combination of its above and current neighbors.

Diagonal-NE: predicts each pixel as a linear combination of its top-left and current neighbors.

Diagonal-NW: predicts each pixel as a linear combination of its top-right and current neighbors.

These modes are often combined into a single mode (e.g., Horizontal+Vertical) to improve prediction accuracy.

When using template-based MPM, the intra prediction modes are typically derived from a set of predefined templates that capture various patterns and shapes found in natural images. These templates are then matched against the block of pixels to determine the most probable mode.

In a decoder-side intra mode derivation approach, both the encoder and decoder use the same template-based method to derive the Intra Prediction mode of a CU. This allows the decoder to accurately predict the values of pixels within the CU, without requiring explicit transmission of the prediction modes from the encoder.

By deriving the Intra Prediction mode on both the encoder and decoder sides, the system can efficiently encode and decode video data, while maintaining high compression efficiency and accurate reconstruction of the original image.

While these types of Intra Prediction modes are useful, they can be improved.

### BRIEF SUMMARY

This section is intended to include examples and is not intended to be limiting.

In an exemplary embodiment, a method is disclosed that includes performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

An exemplary computer program product includes a computer-readable storage medium bearing instructions that, when executed by an apparatus, cause the apparatus to perform at least the following: performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

In another exemplary embodiment, an apparatus comprises means for: performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

In an exemplary embodiment, a method is disclosed that includes performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

An exemplary computer program product includes a computer-readable storage medium bearing instructions that, when executed by an apparatus, cause the apparatus to perform at least the following: performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

In another exemplary embodiment, an apparatus comprises means for: performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

In an exemplary embodiment, a method is disclosed that includes performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

An exemplary computer program product includes a computer-readable storage medium bearing instructions that, when executed by an apparatus, cause the apparatus to perform at least the following: performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

In another exemplary embodiment, an apparatus comprises means for: performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

### BRIEF DESCRIPTION OF THE DRAWINGS

The accompanying drawings use reference numerals, where the same reference numerals may be used to refer to like parts throughout, but parts having the same reference numeral can differ in operation and components. In the attached drawings:

FIG. 1 is a block diagram illustrating a system in accordance with an example;

FIG. 2 illustrates a flowchart of a method for recomputing blending weights of TIMD merge candidates in accordance with a first main example (I);

FIG. 2A illustrates part of a frame that is used to visualize some of the method of FIG. 2;

FIG. 3 illustrates a flowchart of a method for using block vectors from neighboring blocks to replace one or more TIMD Merge predictors in accordance with a second main example (II);

FIG. 3A illustrates part of a frame that is used to visualize some of the method of FIG. 3;

FIG. 4 illustrates a flowchart of a method for partitioning a template into sub-templates in accordance with a third main example (III);

FIGS. 4A and 4B illustrate part of a frame that are used to visualize some of the method of FIG. 4 and illustrate how the templates may be split into sub-templates;

FIG. 5 is a flowchart of a method for encoding a video using template-based intra mode derivation merge improvements in accordance with an example;

FIG. 6 illustrates a VVC encoder where the encoder examples can be implemented;

FIG. 7 is a flowchart of a method for decoding a video using template-based intra mode derivation merge improvements in accordance with an example;

FIG. 8 illustrates a VVC decoder where the decoder examples can be implemented; and

FIG. 9 is an example of a block diagram of an apparatus suitable for implementing any of the encoders or decoders described herein.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the examples.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

s used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that capital and lowercase words or phrases are considered to be the same herein. For instance, the words Slice and slice are the same, as are the phrases Network Repository Function and network repository function.

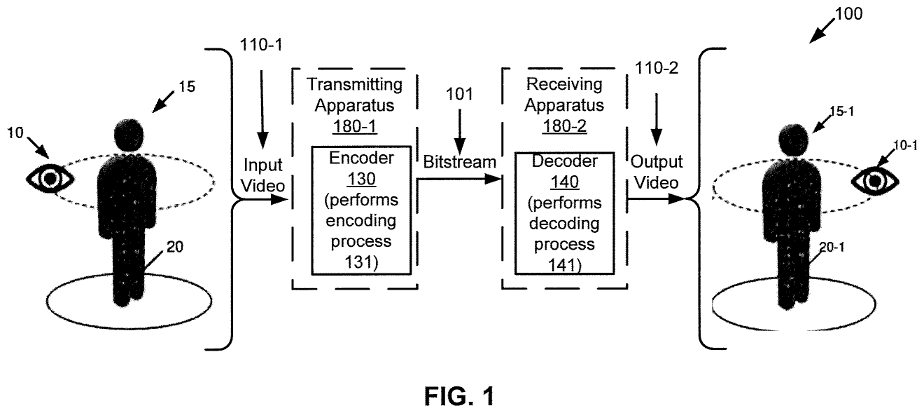

Any flow diagram (see FIGS. 1, 2, 3, 4, 5, and 7) or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. For methods, flow diagrams, and signaling diagrams, the orders of method steps, blocks in the flow, or signaling are not critical and instead are examples.

Technical context is now provided for technical areas related to the understanding of the examples. Template-based intra mode derivation (TIMD) has been proposed in the past. In the context of recent JVET standardization efforts, a variant was adopted in ECM software which relies on the Most Probable Mode (MPM) intra mode list construction to perform the intra mode search. See, e.g., Mohsen Abdoli et al., “Video Compression Beyond VVC: Quantitative Analysis of Intra Coding Tools in Enhanced Compression Model (ECM)”, arXiv: 2404.07872v1 [cs.MM] 11 Apr. 2024 for ECM and “EE2-related: Template-based intra mode derivation using MPMs”, JVET-V0098, Yang Wang, Li Zhang, Kai Zhang, Zhipin Deng, Na Zhang, April 2021 for both ECM and the variant. In particular, for a current block, a template is considered, formed of 4 or 2 lines of reconstructed samples. Depending on the availability of the reference samples, an L-shaped template is used in the surrounding of the current block (in case of complete availability of neighboring reconstructed samples) or a rectangular template either on the left or on top of the current block. The template has a width/height of 2 or 4 samples, depending on the block size. Then the intra modes present in the MPM list are searched one-by-one. Available already reconstructed samples in the surrounding of the template are used as reference samples, where the samples in the template are used as target. A prediction of the target template is obtained from each of the modes in the MPM list. This has also been extended as follows. See “EE2-related: Fusion for template-based intra mode derivation”, JVET-W0123-v2, Keming Cao, et al., 7-16 July 202. A distortion is then computed between that prediction and the original template samples using Sum of Absolute Transformed Differences (SATD) distortion metric. Finally, the two modes at minimum cost are selected; these are blended together using uniform blending, where the weights used in the blending depend on the distortions computed during the intra mode search.

Usage of Template-based Intra Mode Derivation (TIMD) Merge is being investigated in the context of ECM. See R. G. Youvalari, M. Abdoli, “AHG 12: TIMD merge mode”, JVET-AG0106, January 2024. When using TIMD Merge, a prediction is computed for the current block by extracting intra-prediction information from neighboring blocks encoded with the TIMD mode. In particular, the TIMD modes and associated weights are considered to be used in the current block. A template-based search may be performed to sort the various TIMD Merge candidates found in the neighborhood.

TIMD Merge can successfully reduce the overhead needed to signal a current intra prediction mode, but the resulting prediction is often sub-optimal, due to the fact the information extracted from neighboring blocks may not be strongly correlated with the content in the current block. Examples herein propose several improvements to the way TIMD Merge can be used to compute a prediction. In particular, three main examples are proposed: (I) Recomputing blending weights of TIMD merge candidates; (II) Using block vectors from neighboring blocks to replace one or more TIMD Merge predictors; and (III) Partitioning a template into sub-templates. For ease of reference, this topical structure of (I), (II), and (III) is used below.

Prior to proceeding with description of the three main examples, reference is made to FIG. 1, and this figure is a block diagram illustrating a system 100 in accordance with an example. In the example, the encoder 130 is used to encode input video 110-1 from the scene 15, and the encoder 130 is implemented in a transmitting apparatus 180-1. There is a capture of input video at a viewpoint 10 of a scene 15, which includes a human being 20. The encoder 130 produces a bitstream 101, using the encoding process 131 on the input video 110-1, that is received by the receiving apparatus 180-2. The receiving apparatus 180-2 implements a decoder 140, which performs a decoding process 141. The decoder 140, using the decoding process 141 on the bitstream 101, forms the output video 110-2 (as a representation of the input video 110-1) for the scene 15-1, and the receiving apparatus 180-2 would present this to the user, e.g., via a smartphone, television, or projector among many other options. The scene 15-1 has a viewpoint 10-1 and contains representations of at least a human being 20-1. The encoder 130 and decoder 140 may be applied to multiple coding standards.

One such standard is Versatile Video Coding (VVC), which is a new international video coding standard. Enhanced Compression Model (ECM) is built on top of VVC and is potentially a future video coding standard that is currently under the development sponsored by JVET. Both VVC and ECM are block-based video coding standards, where an input picture is divided into CTUs, and each CTU may be further split into CUs. A CU (as one type of block) is coded in either inter-coding mode or intra-coding mode. If the block is in inter-coding mode, the encoder 130 searches for a temporal prediction block in reference picture(s), and signals the decoder 140 how to find the same prediction block in reference picture(s) at the decoder end. If the block is in intra coding mode, the encoder 130 constructs a spatial prediction block from the current picture, and signals the decoder 140 how to form the same spatial prediction block from the current picture at the decoder end.

At the encoder 130 end, the residual block between a current CU (as one type of block) and its prediction block is transformed and quantized. The quantized transform coefficients are entropy coded. The decoder 140, on the other hand, performs inverse operations, such as, entropy decoding, dequantization and inverse transform, to reconstruct the residual block, and reconstructs the CU (or block) by adding the reconstructed residual block to the prediction block.

The three main examples are described now. It is noted that the three main examples describe methods, and the methods may be performed by the encoder 130 (as an encoding process 131) or by the decoder 140 (as a decoding process 141).

### (I) Recomputing Blending Weights of TIMD Merge Candidates

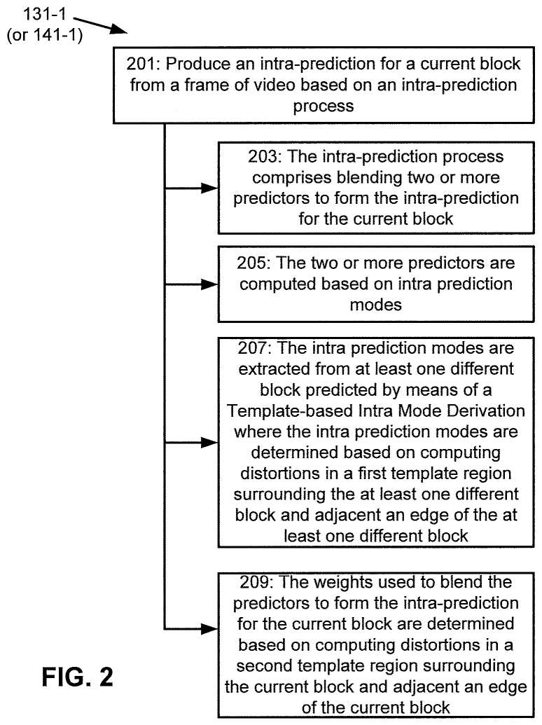

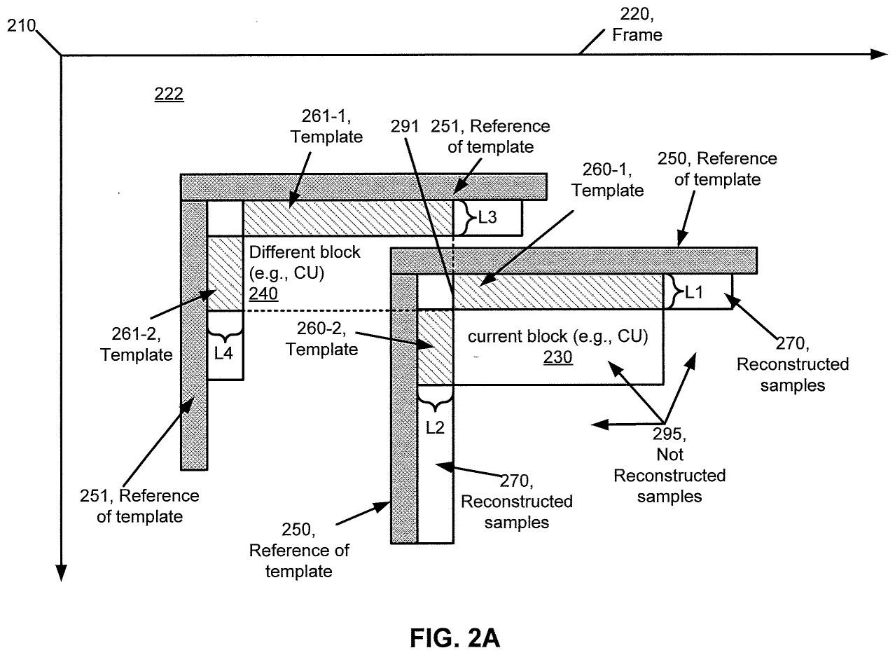

FIG. 2 illustrates a flowchart of a method for recomputing blending weights of TIMD merge candidates in accordance with a first main example (I). This example includes the following. A method (e.g., an encoding process 131-1 or a decoding process 141-1) operating according to this example produces (see block 201) an intra-prediction for a current block based on an intra-prediction process, e.g., blocks 203-209. The intra-prediction process comprises blending (see block 203) two or more predictors to form the intra-prediction for the current block. In block 205, the two or more predictors are computed based on intra prediction modes. In block 207, the intra prediction modes are extracted from at least one different block predicted by means of a Template-based Intra Mode Derivation (TIMD), where the intra prediction modes are determined based on computing distortions in a first template surrounding the at least one different block and adjacent an edge of the at least one different block. In block 209, the weights used to blend the predictors to form the intra-prediction for the current block are determined based on computing distortions in a second template surrounding the current block and adjacent an edge of the current block.

Referring to FIG. 2A, this figure illustrates part 222 of a frame 220 that is used to visualize some of the method of FIG. 2. The current block 230, which could be a CU, is illustrated. The current block 230 is part of the not reconstructed samples 295. In more detail, it is assumed that the encoding process starts at 210 and has proceeded so that the samples that are vertically above sample 291 (the uppermost and leftmost sample of current block 230) have been reconstructed as reconstructed samples 270, as have the samples to the left horizontally from sample 291. The current block 230 has a template 260 having a part 260-1 (a horizontal template at a top edge of the current block 230) and a part 260-2 (a vertical template at a left edge of the current block 230). Parts 260-1 and 260-2 are referred to as templates since they form an entire template. Note that the template that is used can be only left (part 260-2) or only top (part 260-1) when other is not available. The reconstructed samples in templates 260-1 and 260-2 are predicted using a set of reference samples 250. The template 260 surrounds the current block 230 in the sense that the template is a boundary template using the reconstructed samples 270. That is, the template 260 is attached to and bordering two edges (the top and left edges) of the block, which is what is being surrounded.

In this example and for ease of reference, only one different block 240 (e.g., another CU) is shown, and its position is placed for ease of illustration. The different block 240 has a template 260 that has a horizontal template part 261-1 that is adjacent (that is, next to and adjoining) a top edge of the different block 240 and a vertical template part 261-2 that is adjacent a left edge of the different block 240. The parts 261-1 and 262-2 are referred to as templates since they form an entire template. Note that the template that is used can be only left (261-2) or only top (261-1) when other is not available. The reconstructed samples in templates 261-1 and 261-2 are predicted using a set of reference samples 251. The template 261 surrounds the different block 240 in the sense that the template is a boundary template using the reconstructed samples 270. Note that all of the regions 251, 261, 240 are in the reconstructed samples 270. That is, the template 261 is attached to and bordering two edges (the top and left edges) of the block, which is what is being surrounded.

It is noted that the templates 260-1 and 260-2 may contain a different number of samples, such that L1 and L2 might not be the same. Similarly, L3 and L4 for templates 261-1 and 261-2 might not be the same. This is true for other figures herein that use templates, but the number of samples L for those corresponding templates are not indicated in those figures.

The first template 261 is the template for computing distortions that is used in block 207 of FIG. 2 is the template 261-2, although this is merely an example. The second template 260 is the template that is used for computing distortions in block 209 in FIG. 2 for the current block 230.

As other examples, TIMD information is extracted from at least one different block 240, comprising two or more intra prediction modes with corresponding blending weights. These modes were determined on the different block based on computing distortions on a first template adjacent an edge of such different block. As such, the blending weights may not be representative of the content of the current block. For that reason, it makes sense to recompute the blending weights. For this purpose, a template cost is computed using the intra prediction modes to predict already reconstructed samples in a second template adjacent an edge of the current block. The template cost and distortion are used here to mean the same thing in this context: SATD or SAD between the predictor and reconstructed samples over the template area. The corresponding obtained distortions can be used to recompute the blending weights. In particular, higher blending weights can be assigned to intra prediction modes resulting in lower distortions in the second template. That is, higher weight is assigned to a mode with lower distortion, meaning that a mode that has lower distortion is a better predictor and thus should be prioritized. Conversely, lower blending weights can be assigned to intra prediction modes resulting in higher distortions in the second template. In additional detail, a sequence of operations may be as follows. Two or more modes are extracted from a different block. Then, a template distortion is computed on a template surrounding the current block, for each of these modes. And, finally, weights are determined based on these distortions computed for the two or more modes.

As an example, the decoder may select the best weights between the weights determined based on the second template, and the weights extracted from the at least one different block which were determined based on the first template. As an example, assume that two current modes M1 and M2 with two weights W1_ first and W2_first are extracted from a different block. In further detail, every mode has an associated weight computed from its own distortion and the distortion of other mode(s) used in blending. W1_first and W2_first are determined based on computing distortions on a first template adjacent an edge of such different block. Then, the two intra-prediction modes M1 and M2 are used to predict a second template adjacent an edge of the current block, resulting in two distortions D1 and D2. In further detail, D1 is computed using a set of reference samples surrounding the second template, creating a prediction of the samples within the second template area using the mode M1, and then calculating a distortion between the actual reconstructed samples in the second template and the predicted samples. This difference may be SATD or SAD, or the like, which may be referred to as either the template cost of the mode or distortion of the mode, which are used interchangeably. Similarly, D2 is computed following the same process using the mode M2. The corresponding obtained distortions D1 and D2 are used to determine two new weights W1_second and W2_second. As an example, W1_second can be computed as:

$$W1\_second = ( 64 * D 2 ) / ( D 1 + D 2 ) .$$

And, as an example, W2_second can be computed as:

$$W2\_second = ( 64 * D 1 ) / ( D 1 + D 2 ) .$$

Then a first weighted cost may be computed as:

$$C\_first = W1\_first * D 1 + W2\_first * D 2.$$

Similarly, a second weighted cost is computed as the following:

$$C\_second = W1\_second * D 1 + W2\_second * D 2.$$

Finally, the decoder selects which set of weights to use based on C_first and C_second. In particular:

If C_first<C_second, then use W1_first and W2_first;

Else use W1_second and W2_second.

A similar process can be used in case more than two modes are extracted. For instance, a similar process can be used in case three modes are extracted from a different block.

### (II) Using Block Vectors From Neighboring Blocks to Replace One or More TIMD Merge Predictors

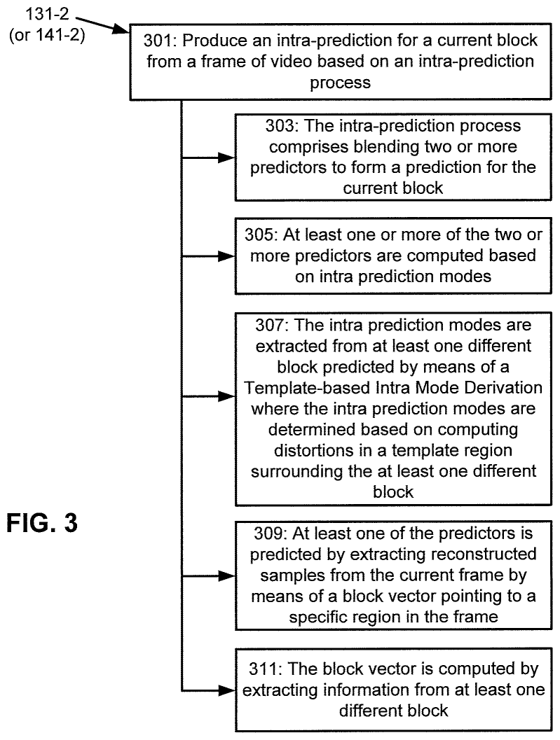

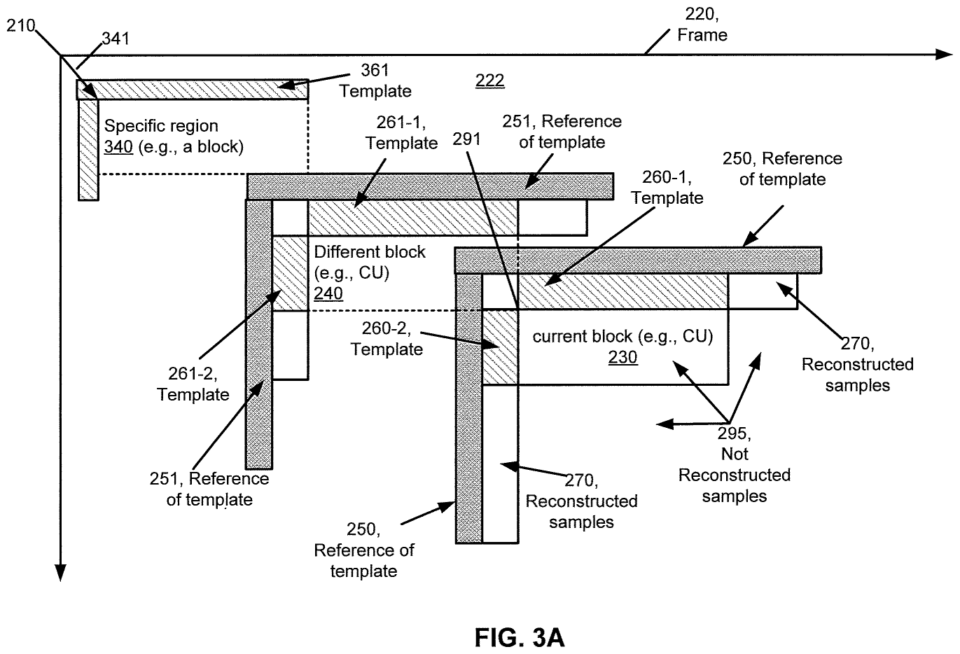

FIG. 3 illustrates a flowchart of a method for using block vectors from neighboring blocks to replace one or more TIMD Merge predictors in accordance with a second main example (II). A method (e.g., an encoding process 131-2 or decoding process 141-2) operating according to this example produces (see block 301) an intra-prediction for a current block based on an intra-prediction process, e.g., see blocks 303-311. The intra-prediction process comprises (see block 303) blending two or more predictors to form a prediction for the current block, where (see block 305) at least one or more of the two or more predictors are computed based on intra prediction modes. In block 307, the intra prediction modes are extracted from at least one different block predicted by means of a Template-based Intra Mode Derivation (TIMD), where the intra prediction modes are determined based on computing distortions in a template adjacent an edge of the at least one different block. In block 309, at least one of the predictors is predicted by extracting reconstructed samples from the current frame by means of a block vector pointing to a specific region in the frame, where (see block 311) the block vector is computed by extracting information from at least one different block. It is noted that the “at least one different block” here (in block 311) does not necessarily have to be the same different block as in block 307.

Consider the example of FIG. 3A, which illustrates part of a frame that is used to visualize some of the method of FIG. 3. FIG. 3A is similar to FIG. 2A, and only differences are described herein. In FIG. 3A, the template 260, including 261-1 and 261-2, is the template that is used in this example for computing distortions in block 307 of FIG. 3 for the different block 240. The specific region 340 (e.g., a block) is pointed to by a block vector 341, which is in block 309 of FIG. 3.

As an example, TIMD information is extracted from at least a different block, comprising one or more intra prediction modes with corresponding blending weights. The extracted TIMD information may indicate that at least one of the blended modes is a block vector-based intra prediction mode. In this case, when the extracted information is used for creating a prediction for the current block, the block vector (BV) can be tested for validity and applied to the current block as a predictor in case the area to which the block vector refers to is valid. When the extracted block vector is not valid for the current block, the BV based predictor might be replaced with a pre-determined intra prediction mode, such as the PLANAR mode, or the TIMD information from that block might be discarded. The term “predetermined” means something fixed, i.e. if BV is not valid always use mode 0 (zero) or the first mode from a list of fixed modes that is not used already as a predictor in this block, or the like. A method therefore can determine whether the extracted block vector is valid for the current block, where a block vector is determined to be valid depending on an area that the block vector refers to and availability of the samples in that area. Then, when the block vector extracted from the different block is determined to be not valid for the current block, the block-vector-based intra prediction mode is replaced with a pre-determined intra prediction mode. When the block vector extracted from the different block is determined to be not valid for the current block, another block vector that is valid for the current block can be used for block vector-based predictor generation.

Alternatively, when TIMD information is extracted from a different block which indicates usage of BV based predictor, a list of potential valid BVs can be generated. These potential BVs can be ranked based on their distortions calculated over a template adjacent an edge of the current block, and might be also compared together with the predictors obtained with the extracted TIMD information. Blending of the BV based predictors might use weights extracted from the block where the TIMD information is extracted from, or alternatively the weights may be recomputed based on the distortions computed over a template.

As another example, when TIMD information is extracted from a different block and that block indicates usage of a BV based predictor, instead of using the BV from that source block, a process is created to decide what is a good BV based predictor for the current block. That is, a list of BVs is generated along with calculating their distortions, i.e., checking how well they predict a selected template, and the process can then pick the best one (e.g., being the one with least distortion) to be used in blending.

In another case, when the TIMD information extracted from a different block indicates usage of BV based prediction, the BVs can be tested for validity and marked as valid in case the area that block vector refers to points to already reconstructed samples within the frame.

As another example, a list of valid BVs for the current block can be determined by extracting information from different blocks. As an example, a number of different blocks can be traversed, where if such block is predicted using a BV, then such BV can be included in the list for the current block. That is, a block may be traversed (in some fashion, can be for example position based—one can check a location and fetch the CU this position falls into) and check the prediction-mode related information. The BVs in the list can be tested for validity, where all the non-valid BVs can be removed from the list. As an example, when the TIMD information extracted from a different block indicates that one of the blended modes is a BV based intra prediction mode, then the corresponding BV can be replaced with a different BV extracted from the list. The process of replacing a current BV extracted from a TIMD neighbor with a different BV may depend on computing costs based on distortions computed over a template area.

As another example, a method can include, when the template-based intra mode derivation information is extracted from the at least one different block that indicates usage of a block vector-based predictor, generating a list of potential valid block vectors for the current block by extracting block vector information from previously coded blocks that utilized at least one block vector in prediction. This method could also include generating at least one new candidate for a merge list, where block vector-based predictor is using the block vector from the generated list of potential valid block vectors.

A further example is a method that includes, when the template-based intra mode derivation information is extracted from the at least one different block that indicates usage of block vector-based predictor, generating a list of potential valid block vectors for the current block by extracting block vector information from previously coded blocks that utilized at least one block vector in prediction. The list of potential valid block vectors can be ranked based on their distortions calculated over corresponding templates for blocks pointed to by the potential valid block vectors and the template for the current block. At least one new candidate can be generated for a merge list where block vector-based predictor is using the block vector from the ranked list of block vectors. For instance, consider the specific region 340 in FIG. 3A that is pointed to by the BV 341. The specific region 340 may be or contain a block similar to the different block 240 or current block 230 and having a corresponding template 361 as in 261 or 260. Distortions may be calculated over corresponding templates 361 for blocks 340 pointed to by the potential valid block vectors 341 and the template 260 for the current block 230.

Another example includes determining a list of valid block vectors for the current block by extracting information from the at least one different block. Determining the list of valid block vectors includes testing block vectors in the list for validity, where all the non-valid block vectors are removed from the list.

### (III) Partitioning a Template Into Sub-Templates

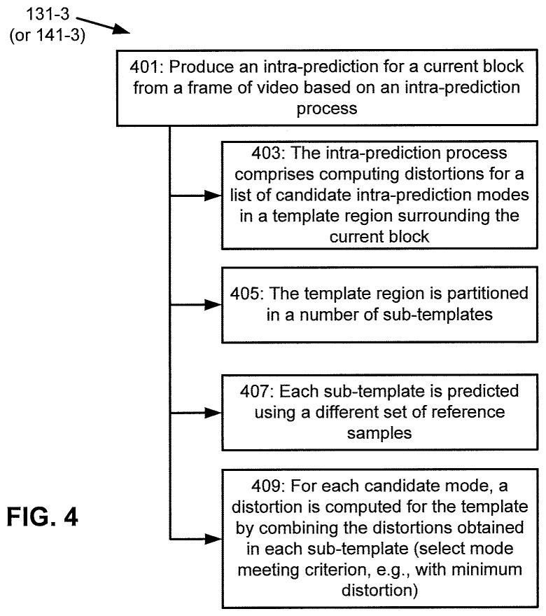

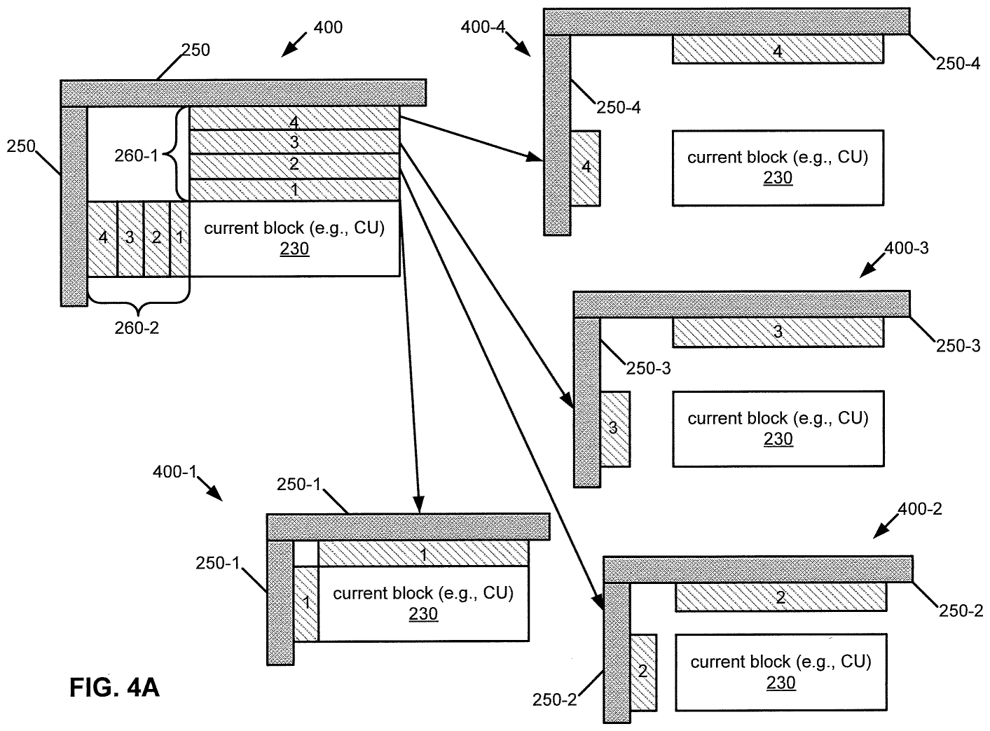

FIG. 4 illustrates a flowchart of a method for partitioning a template into sub-templates in accordance with a third main example (III). A method (e.g., an encoding method 131-3 or a decoding method 141-3) operating according to this example produces (see block 401) an intra-prediction for a current block based on an intra-prediction process, e.g., see blocks 403-409. The intra-prediction process comprises (see block 403) computing distortions for a list of candidate intra-prediction modes in a template surrounding the current block, where (see block 405) the template is partitioned into a number of sub-templates. In block 407, each sub-template is predicted using a different set of reference samples, where (see block 409) for each candidate mode, a distortion is computed for the template by combining the distortions obtained in each sub-template. One distortion is computed for each mode in the list of candidate motes. A selection is made of the mode or modes meeting a criterion, e.g., with minimum distortion.

In further detail, this may seem similar to main TIMD, as there are several modes and a distortion is calculated for each of them to rank them. The difference from base TIMD, however, is in how the distortion value for each mode is calculated—so different distortion calculation may end up providing a different mode as the best, e.g., final predictor. For the distortion calculation, instead of using one line for reference and creating the prediction of all the samples within the template region from that one line, the template region is split in a number of sub-templates, and each sub-template is predicted using a different set of reference samples, which may be the samples that are closest to the sub-template (so the reference samples for each sub-template changes). A distortion ca be computed for each sub-template to measure the difference between the reconstructed samples within the sub-template and the predicted samples. A total distortion for the template can then be computed as the sum of the distortions obtained in the sub-templates. This distortion is now different from the one obtained in the TIMD process, hence potentially leading to selecting different intra modes. This also has another motivation, which is to be able reuse template costs that are already calculated for a smaller template area, in the calculation of a larger template area which includes that smaller one.

Turning to FIG. 4A, this figure illustrates a partitioning method to partition (see block 405 of FIG. 4) templates 260 into sub-templates. In this example, the template 460-1 is partitioned into sub-templates 1, 2, 3, and 4, and the template 460-2 is partitioned into sub-templates 1, 2, 3, and 4. For ease of reference, these will be referred to as sub-partitions 1, 2, 3, or 4, and this means corresponding sub-partitions for templates 460-1 and 460-2.

Reference 400 illustrates a figure for the current TIMD template cost determination, while references 400-1, 400-2, 400-3, and 400-4 illustrate the “split” TIMD template costs for corresponding sub-partitions 1, 2, 3, and 4. Reference 400-1 shows the outcome of partitioning for sub-templates 1, where the reference 250-1 is moved to be adjacent the sub-templates 1. Reference 400-2 shows the outcome of partitioning for sub-templates 2, where the reference 250-2 is moved to be adjacent the sub-templates 2. Reference 400-3 shows the outcome of partitioning for sub-templates 3, where the reference 250-3 is moved to be adjacent the sub-templates 3. Reference 400-4 shows the outcome of partitioning for sub-templates 4, where the reference 250-4 is moved to be adjacent the sub-templates 4.

Referring to FIG. 4B, this figure illustrates another partitioning method to partition (see block 405 of FIG. 4) templates 260 into sub-templates. In this example, the template 260-1 is horizontally partitioned into two sub-templates 460-1 and 460-2. The template 260-2 is vertically partitioned into sub-templates 460-3 and 460-4.

As an example, the template may be partitioned into a current number of sub-templates. As an example, the size of the sub-templates may depend on the size of the full template. As an example, each sub-template may comprise a fixed number of rows and/or columns of already reconstructed samples.

For each sub-template, a set of reference samples can be considered. As an example, these reference samples may comprise the already reconstructed samples adjacent to the sub-template, immediately above and immediately on the left of the sub-template. As an example, the reference samples may extend further on the right of the sub-template, and/or further below the sub-template.

As an example, if the template is specified to have a size of 4 lines, then this may be partitioned into two sub-templates of two lines each. As an example, the first sub-template may be predicted using reference line with Multiple Reference Line index 2, whereas the second sub-template may be predicted using reference line with Multiple Reference Line index 4.

As an example, different intra-prediction modes may use different sub-template sizes. As an example, the sub-template size may depend on whether a current directional intra-prediction mode is horizontal or vertical. As an example, the usage of sub-templates and/or the sub-template size may depend on whether a current intra-prediction mode was used within another Template-based Intra Mode Derivation process.

As an example, in case the decoder allows two or more Template-based Intra Mode Derivation processes, where the different processes may use different template sizes, then one TIMD process may specify the sub-template size based on the template size used in another TIMD process. As an example, if two TIMD processes using different distortion metrics are used, then the size of the sub-templates used in the second TIMD process may be determined based on the size of the templates used in the first TIMD process. As an example, if two TIMD processes using different template sizes are used, then the size of the sub-templates used in the second TIMD process may be determined based on the size of the templates used in the first TIMD process. This may allow reusing predictions computed in the first TIMD process within the second TIMD process.

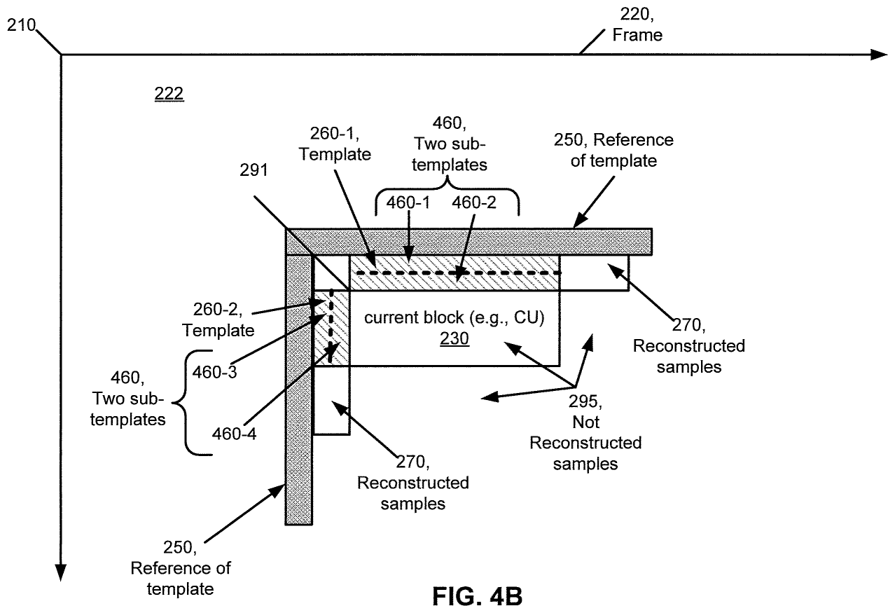

Referring to FIG. 5, this figure is a flowchart of a method for encoding a video that uses template-based intra mode derivation merge improvements in accordance with an example. In block 505, an encoder 130 receive/accesses video 110-1 having frames. The encoder 130 splits individual frames of video into blocks in block 510. In block 520, the encoder 130 processes blocks by intra-and inter-frame predictions. For the intra-frame predictions, the encoder 130 performs the method of one of FIG. 2, 3, or 4 for individual blocks, and selects a prediction for the individual blocks based on the predictions. See block 530. There are multiple ways of creating an intra prediction, including TIMD and the examples herein. Some modes are simply select a predictor, other modes such as TIMD derive the predictors to create a final prediction at the encoder and decoder side (there is no signaling of the predictors but just the mode). The encoder selects which mode to use based on the rate-distortion cost for the current block. In block 540, the encoder 130 performs other processing on blocks until an (encoded) bitstream 101 is formed. The encoder 130 outputs the (encoded) bitstream in block 550, including signaling that a mode should be performed of a process for template-based intra mode derivation merge. It is noted that it is possible to not signal usage of any of the methods herein. That is, these methods may work on top of TIMD Merge and/or normal TIMD. The encoder will already use flags signalling usage of TIMD Merge and/or normal TIMD. When using one of the example methods herein, the corresponding modifications will be used when performing TIMD Merge and/or normal TIMD. The signalling need not be impacted.

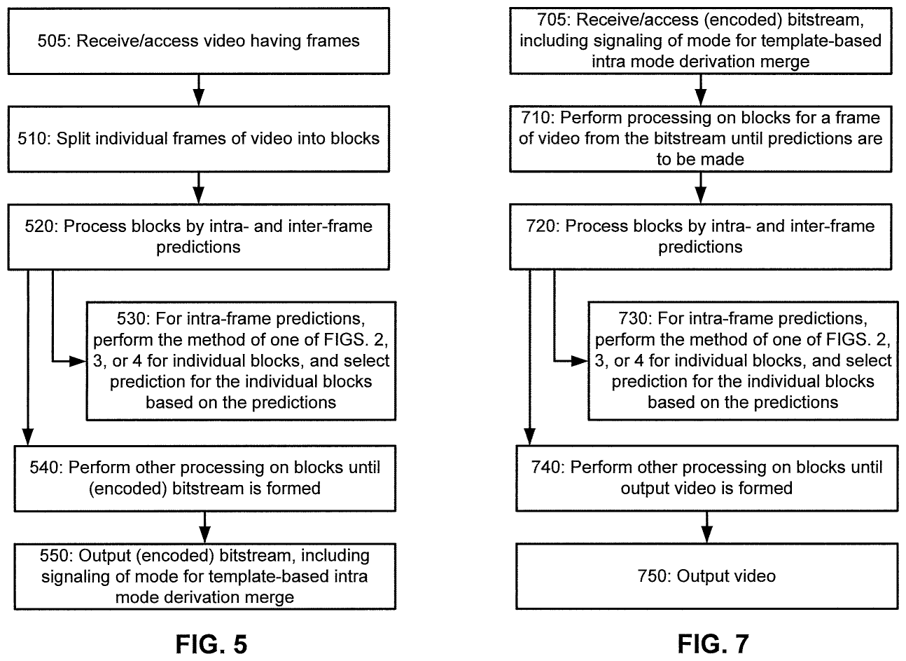

Referring to FIG. 6, this figure illustrates a VVC encoder 600 where the encoder examples can be implemented. The examples can be implemented in the intra-predictor (Pᵢₙₜᵣₐ) 608. It is noted that the terms “image” and “picture” are considered to be the same herein. The encoder 600 is a base layer and other layers (not shown) may be added to the base layer. The encoder 600 comprises a pixel predictor 602, prediction error encoder 603, and prediction error decoder 604. FIG. X also shows an embodiment of the pixel predictor 602 as comprising an inter-predictor (Pᵢₙₜₑᵣ) 606, an intra-predictor (Pᵢₙₜᵣₐ) 608, a mode selector 610, a filter (F) 616, and a reference frame memory (RFM) 618. The pixel predictor 602 of the encoder 600 receives base layer pictures (I_{0,n}) 601 of input video 110-1 (e.g., a video stream) to be encoded at both the inter-predictor 606 (which determines the difference between the picture and a motion compensated reference frame from the RFM 618) and the intra-predictor 608 (which determines a prediction for an image block based only on the already processed parts of the current picture from a base layer picture 601). The output of both the inter-predictor 606 and the intra-predictor 608 are passed to the mode selector 610. The intra-predictor 608 may have more than one intra-prediction mode. Hence, each mode may perform the intra-prediction and provide the predicted signal to the mode selector 610. The mode selector 610 also receives a copy of the base layer pictures (I_{0,n}) 601.

Depending on which encoding mode is selected to encode the current block, the output of the inter-predictor 606, or the output of one of the intra-predictor 608 modes, or the output of a surface encoder within the mode selector 610 is passed to the output of the mode selector 610. The output of the mode selector 610 is passed to first summing device 621 and comprises the prediction representation of the image block (P′ₙ) 612. The first summing device 621 may subtract the prediction representation of the image block (P′ₙ) 612 of the pixel predictor 602 from the base layer picture 601 to produce a first prediction error signal (Dₙ) 620, which is input to the prediction error encoder 603.

The pixel predictor 602 further receives from a second summing device 639, which acts as a preliminary reconstructor, the combination of the prediction representation of the image block (P′ₙ) 612 and the prediction error signal (D′ₙ) 638 of the prediction error decoder 604. The preliminary reconstructed picture (rₙ) 614 may be passed to the intra-predictor 608 and to a filter (F) 616. The filter 616 receiving the preliminary representation may filter the preliminary representation and output a final reconstructed picture 640, which may be saved in the reference frame memory (RFM) 618. The reference frame memory 618 may be connected to the inter-predictor 606 to be used as the reference picture against which a future base layer picture 601 is compared in inter-prediction operations.

The prediction error encoder 603 comprises a transform unit (T) 642 and a quantizer (Q) 644. The transform unit 642 transforms the first prediction error signal 620 to a transform domain. The transform is, for example, the DCT (discrete cosine transform). The quantizer 644 quantizes the transform domain signal, e.g., the DCT coefficients, to form quantized coefficients.

The prediction error decoder 604 receives the output from the prediction error encoder 603, and performs the opposite processes of the prediction error encoder 603 to produce a decoded prediction error signal (D′ₙ) 638 which, when combined with the prediction representation of the image block 612 at the second summing device 639, produces the preliminary reconstructed picture 614. The prediction error decoder 604 may be considered to comprise a dequantizer (Q⁻¹) 646, which dequantizes the quantized coefficient values, e.g., DCT coefficients, to reconstruct the transform signal and an inverse transformation unit (T⁻¹) 648, which performs the inverse transformation to the reconstructed transform signal wherein the output of the inverse transformation unit 648 contains reconstructed block(s). The prediction error decoder 604 may also comprise a block filter (not shown) which may filter the reconstructed block(s) according to further decoded information and filter parameters.

The entropy encoder 630 receives the output of the prediction error encoder 603 and may perform a suitable entropy encoding/variable length encoding to provide error detection and correction capability. The output of the entropy encoder 630 can be influenced by the signaling 606 from the mode selector 610, e.g., which can indicate, e.g., whether inter prediction or intra prediction is being used. The output of the entropy encoder 630 may be inserted into a bitstream 101. Entropy coding/decoding may be performed in many ways. For example, context-based coding/decoding may be applied, where in both the encoder and the decoder modify the context state of a coding parameter based on previously coded/decoded coding parameters. Context based coding may for example be context adaptive binary arithmetic coding (CABAC), or context-based variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy—coded bitstream or codewords may be referred to as parsing.

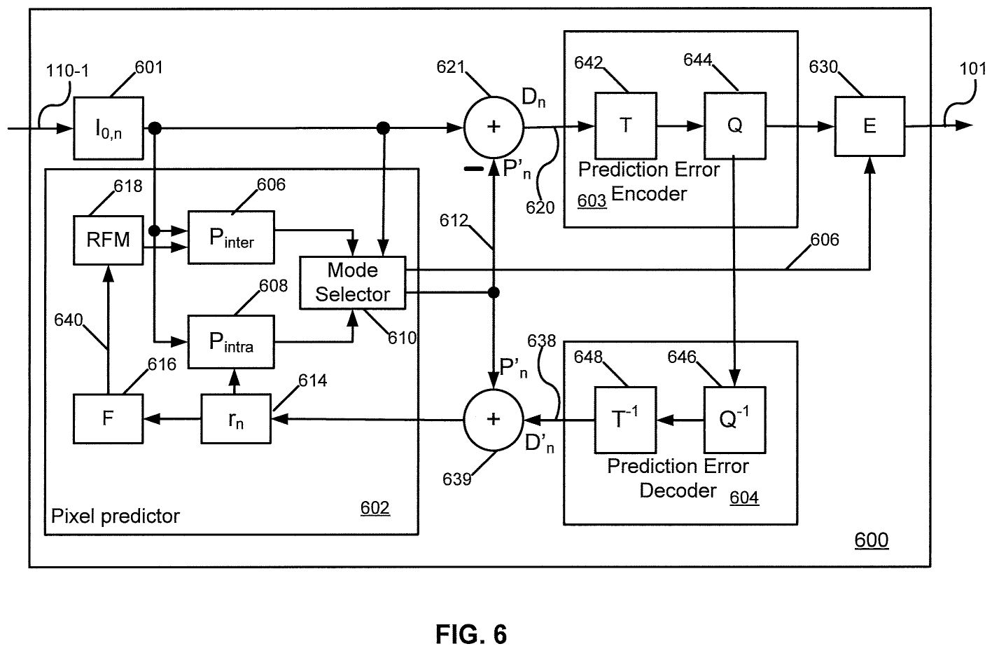

FIG. 7 is a flowchart of a method for decoding a video using template-based intra mode derivation merge improvements in accordance with an example. In block 705, a decoder 140 receive/accesses an (encoded) bitstream 101, including signaling that TIMD Merge and/or normal TIMD is used, and the method(s) herein may then be implemented. In block 710, the decoder performs processing on blocks for a frame of video from the bitstream until predictions are to be made. In block 720, the decoder 140 processes blocks by intra- and inter-frame predictions. For the intra-frame predictions, the decoder 140 performs the method of one of FIG. 2, 3, or 4 for individual blocks, and selects prediction for the individual blocks based on the predictions. In block 740, the decoder 140 performs other processing on blocks until output video is formed, and in block 750, the decoder 140 outputs the video 110-2.

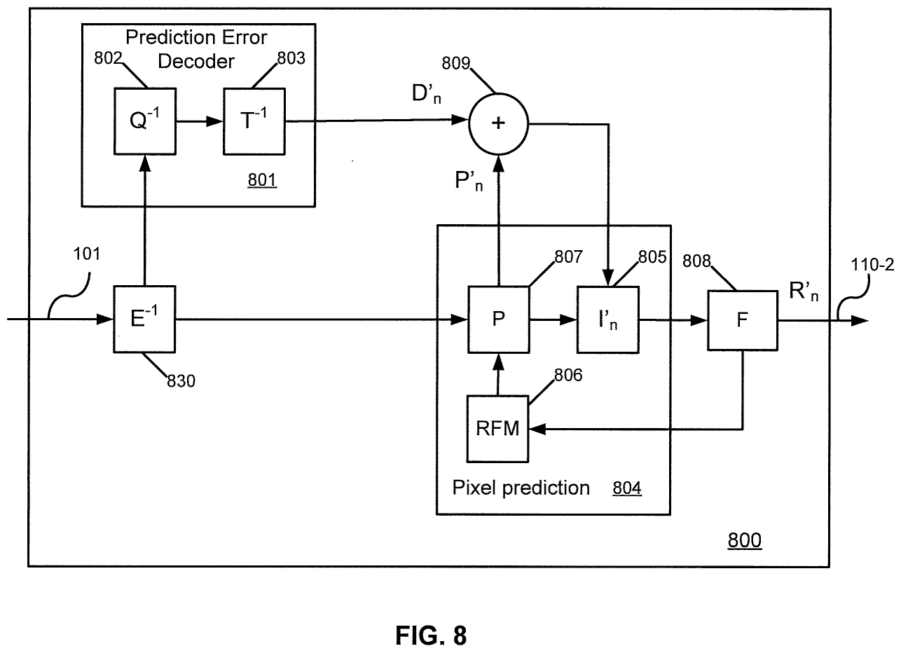

Turning to FIG. 8, this figure illustrates a VVC decoder 800 where the decoder examples can be implemented. The video decoder 800 is coupled to the bitstream 101. The examples herein can be implemented in the block 807, which here illustrates prediction (P) (either inter-prediction or intra-prediction, although intra-prediction is addressed herein). There is a prediction error decoder 801 and a pixel prediction 804. For the prediction error decoder 801, block 803 illustrates inverse transforms (T⁻¹), and block 802 illustrates inverse quantization (Q⁻¹). Block 830 illustrates entropy decoding (E⁻¹) that has an output for the pixel prediction 804. Reference P′ₙ stands for a predicted representation of an image block. Reference D′ₙ stands for a reconstructed prediction error signal. In pixel prediction 804, block 805 illustrates preliminary reconstructed pictures (I′ₙ) based on the P′ₙ from block 807 and the output of the adder 809, block 807 illustrates prediction (P) (either inter-prediction or intra-prediction), which produces P′ₙ for the adder 809 and as the block 805. Block 830 illustrates entropy decoding (E⁻¹). and block 806 illustrates a reference frame memory (RFM). Adder 809 may be used to combine decoded prediction error information (D′ₙ) with predicted base layer/predicted layer pictures (P′ₙ) to obtain the preliminary reconstructed pictures (I′ₙ) 805. Block 808 illustrates filtering (F) and reference R′ₙ stands for a final reconstructed picture in an output video (e.g., stream) 110-2.

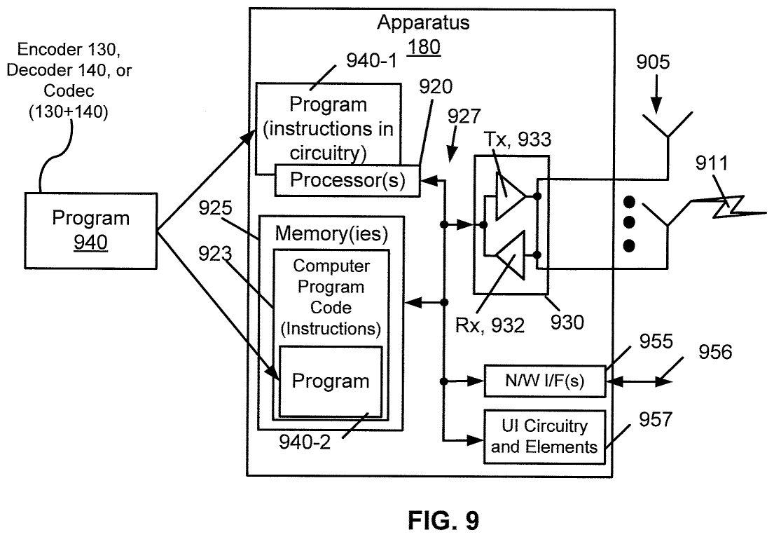

Turning to FIG. 9, this figure is an example of a block diagram of an apparatus 180 suitable for implementing any of the encoders or decoders described herein. The apparatus 180 includes circuitry comprising one or more processors 920, one or more memories 925, one or more transceivers 930, one or more network (N/W) interface(s) (I/F(s)) 955 and user interface (UI) circuitry and elements 957, interconnected through one or more buses 927. Depending on implementation, some apparatus may not have all of the circuitry. For example, an apparatus 180 might not have UI circuitry and elements 957. An apparatus may have additional circuitry, not described here. FIG. 9 is presented merely as an example.

Each of the one or more transceivers 930 includes a receiver, Rx, 932 and a transmitter, Tx, 933. The one or more buses 927 may be address, data, and/or control buses, and may include any interconnection mechanism, such as a series of lines on a motherboard or integrated circuit, fiber optics or other optical communication equipment, and the like. The one or more transceivers 930 are connected to one or more antennas 905, and may communicate using wireless link 911, which could implement any number of wireless communication interfaces such as Wi-Fi, cellular, or satellite.

The one or more memories 925 include computer program code 923. The apparatus 180 includes a program 940, comprising one of or both parts 940-1 and/or 940-2. The program 940 may implement an encoder 130, a decoder 140, or a codec (130 +140), which implements both encoding and decoding. The program itself may be implemented in a number of ways. The program 940 may be implemented in circuitry as program 940-1, such as being implemented as part of the one or more processors 920, and contains instructions implemented in circuitry. The program 940-1 may be implemented also as an integrated circuit or through other circuitry such as a programmable gate array. In another example, the program 940 may be implemented as program 940-2, which is implemented as computer program code (having corresponding instructions) 923 and is executed by the one or more processors 920. For instance, the one or more memories 925 store instructions that, when executed by the one or more processors 920, cause the apparatus 180 to perform one or more of the operations as described herein.

The network interface(s) (N/W I/F(s)) 955 are wired interfaces communicating using link(s) 956, which could be fiber optic or other wired interfaces. The apparatus 180 could include only wireless transceiver(s) 930, only N/W I/Fs 955, or both wireless transceiver(s) 930 and N/W I/Fs 955.

The apparatus 180 may or may not include UI circuitry and elements 957. These could include a display such as a touchscreen, speakers, or interface elements such as for headsets. For instance, an apparatus 180 of a smartphone would typically include at least a touchscreen and speakers. The UI circuitry and elements 957 may also include circuity to communicate with external UI elements (not shown) such as displays, keyboards, mice, headsets, and the like.

The computer readable memories 925 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The processor(s) 920 may be of any type suitable to the local technical environment, and may include one or more of general-purpose computers, special purpose computers, microprocessors, digital signal processors (DSPs) and processors based on a multi-core processor architecture, as non-limiting examples. The processor(s) 920 control the apparatus 180 to perform the operations as described herein. The processor(s) 920 may execute instructions, including microcode, but are not implemented solely in software.

Without in any way limiting the scope, interpretation, or application of the claims appearing below, a technical effect and/or advantage of one or more of the example embodiments disclosed herein is recomputing weights is performed, which means better compression efficiency (meaning better predictors, less distortion at the same signaling cost). Another technical effect and/or advantage of one or more of the example embodiments disclosed herein is split templates may be used, which results in reduced computations at the encoder. Another technical effect and/or advantage of one or more of the example embodiments disclosed herein is BV based predictors in TIMD merge, which results in better compression efficiency (meaning better predictors, less distortion at the same signaling cost).

The following are additional examples.

Example 1. A method, comprising: performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

Example 2. The method according to example 1, further comprising: computing a template distortion for each of the two or more intra-prediction modes, where each intra-prediction mode is used to predict already reconstructed samples in the second template that is adjacent the one or more edges of the current block; and assigning individual ones of the blending weights to individual ones of the predictors based on the computed template distortions.

Example 3. The method according to example 2, wherein a highest blending weight among the blending weights assigned to the predictors is assigned to a predictor obtained with an intra-prediction mode resulting in a lowest distortion among the distortions computed on the second template using the two or more intra-prediction modes extracted from the at least one different block.

Example 4. The method according to example 2, wherein a lowest blending weight among the blending weights assigned to the predictors is assigned to a predictor obtained with the intra-prediction mode resulting in a highest distortion among the distortions computed on the second template using the two or more intra-prediction modes extracted from thee at least one different block.

Example 5. The method according to example 1, further comprising selecting one or more blending weights to use between weights determined based on computing distortions in the second template and weights extracted from the at least one different block predicted by using a template-based intra mode derivation, where the weights are determined based on computing distortions in the first template.

Example 6. The method according to example 1, wherein: a first set of blending weights are determined based on computed distortions in the first template adjacent the one or more edges of the at least one different block; a second set of blending weights are determined based on computed distortions in the second template adjacent the one or more edges of the current block; a first cost is determined based on the first set of blending weights and the computed distortions in the second template; a second cost is determined based on the second set of blending weights and the computed distortions in the second template; and the blending weights to form the intra-prediction for the current block are selected between the first set or second set based on the first and second costs.

Example 7. A method, comprising: performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

Example 8. The method according to example 7, where template-based intra mode derivation information is extracted from the at least one different block, and comprises one or more of the intra-prediction modes with corresponding blending weights.

Example 9. The method according to example 8, wherein the extracted template-based intra mode derivation information indicates that at least one of the intra-prediction modes is a block-vector-based intra-prediction mode.

Example 10. The method according to example 9, wherein the extracted template-based intra mode derivation information includes at least one block vector extracted from the at least one different block.

Example 11. The method according to example 10, wherein the method further comprises determining whether the extracted block vector is valid for the current block, where the extracted block vector is determined to be valid depending on an area that the extracted block vector refers to and availability of the samples in that area.

Example 12. The method according to example 11, wherein, when the extracted block vector is determined to be not valid for the current block, the block-vector-based intra-prediction mode is replaced with a pre-determined intra-prediction mode.

Example 13. The method according to example 11, wherein when the extracted block vector is determined to be not valid for the current block, another block vector that is valid for the current block is used for block vector-based predictor generation.

Example 14. The method according to example 9, wherein: when the template-based intra mode derivation information is extracted from the at least one different block that indicates usage of a block vector-based predictor, generating a list of potential valid block vectors for the current block by extracting block vector information from previously coded blocks that utilized at least one block vector in prediction; and generating at least one new candidate for a merge list, where block vector-based predictor is using the block vector from the generated list of potential valid block vectors.

Example 15. The method according to example 9, wherein: when the template-based intra mode derivation information is extracted from the at least one different block that indicates usage of block vector-based predictor, generating a list of potential valid block vectors for the current block by extracting block vector information from previously coded blocks that utilized at least one block vector in prediction; ranking the list of potential valid block vectors based on their distortions calculated over corresponding templates for blocks pointed to by the potential valid block vectors and the template for the current block; and generating at least one new candidate for a merge list where block vector-based predictor is using the block vector from the ranked list of block vectors.

Example 16. The method according to example 7, further comprising determining a list of valid block vectors for the current block by extracting information from the at least one different block.

Example 17. The method according to example 16, wherein determining the list of valid block vectors comprises testing block vectors in the list for validity, where all non-valid block vectors are removed from the list.

Example 18. A method, comprising: performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

Example 19. The method according to example 18, wherein sizes of the sub-templates depend on the size of the template.

Example 20. The method according to example 18, wherein a set of reference samples used to compute the samples in a sub-template comprises already reconstructed samples adjacent to the sub-template, immediately above and immediately on a left edge of the sub-template.

Example 21. The method according to any of examples 1 to 20, further comprising performing one of the following: the producing the intra-prediction for the current block based on the intra-prediction process is performed as part of an encoding process to encode the video into a bitstream, and the method further comprises: forming the bitstream based at least on the intra-prediction process, and outputting the bitstream; or the producing the intra-prediction for the current block based on the intra-prediction process is performed as part of a decoding process to decode the video that has been encoding into a bitstream, and the method further comprises: forming an output video based at least on the intra-prediction process, and outputting the output video.

Example 22. An apparatus, comprising means for: performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

Example 23. The apparatus according to example 22, wherein the means are further configured for: computing a template distortion for each of the two or more intra-prediction modes, where each intra-prediction mode is used to predict already reconstructed samples in the second template that is adjacent the one or more edges of the current block; and assigning individual ones of the blending weights to individual ones of the predictors based on the computed template distortions.

Example 24. The apparatus according to example 23, wherein a highest blending weight among the blending weights assigned to the predictors is assigned to a predictor obtained with an intra-prediction mode resulting in a lowest distortion among the distortions computed on the second template using the two or more intra-prediction modes extracted from the at least one different block.

Example 25. The apparatus according to example 23, wherein a lowest blending weight among the blending weights assigned to the predictors is assigned to a predictor obtained with the intra-prediction mode resulting in a highest distortion among the distortions computed on the second template using the two or more intra-prediction modes extracted from thee at least one different block.

Example 26. The apparatus according to example 22, wherein the means are further configured for selecting one or more blending weights to use between weights determined based on computing distortions in the second template and weights extracted from the at least one different block predicted by using a template-based intra mode derivation, where the weights are determined based on computing distortions in the first template.

Example 27. The apparatus according to example 22, wherein: a first set of blending weights are determined based on computed distortions in the first template adjacent the one or more edges of the at least one different block; a second set of blending weights are determined based on computed distortions in the second template adjacent the one or more edges of the current block; a first cost is determined based on the first set of blending weights and the computed distortions in the second template; a second cost is determined based on the second set of blending weights and the computed distortions in the second template; and the blending weights to form the intra-prediction for the current block are selected between the first set or second set based on the first and second costs.

Example 28. An apparatus, comprising means for: performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

Example 29. The apparatus according to example 28, where template-based intra mode derivation information is extracted from the at least one different block, and comprises one or more of the intra-prediction modes with corresponding blending weights.

Example 30. The apparatus according to example 29, wherein the extracted template-based intra mode derivation information indicates that at least one of the intra-prediction modes is a block-vector-based intra-prediction mode.

Example 31. The apparatus according to example 30, wherein the extracted template-based intra mode derivation information includes at least one block vector extracted from the at least one different block.

Example 32. The apparatus according to example 31, wherein the means are further configured for determining whether the extracted block vector is valid for the current block, where the extracted block vector is determined to be valid depending on an area that the extracted block vector refers to and availability of the samples in that area.

Example 33. The apparatus according to example 32, wherein, when the extracted block vector is determined to be not valid for the current block, the block-vector-based intra-prediction mode is replaced with a pre-determined intra-prediction mode.

Example 34. The apparatus according to example 32, wherein when the extracted block vector is determined to be not valid for the current block, another block vector that is valid for the current block is used for block vector-based predictor generation.

Example 35. The apparatus according to example 30, wherein: when the template-based intra mode derivation information is extracted from the at least one different block that indicates usage of a block vector-based predictor, generating a list of potential valid block vectors for the current block by extracting block vector information from previously coded blocks that utilized at least one block vector in prediction; and generating at least one new candidate for a merge list, where block vector-based predictor is using the block vector from the generated list of potential valid block vectors.

Example 36. The apparatus according to example 30, wherein: when the template-based intra mode derivation information is extracted from the at least one different block that indicates usage of block vector-based predictor, generating a list of potential valid block vectors for the current block by extracting block vector information from previously coded blocks that utilized at least one block vector in prediction; ranking the list of potential valid block vectors based on their distortions calculated over corresponding templates for blocks pointed to by the potential valid block vectors and the template for the current block; and generating at least one new candidate for a merge list where block vector-based predictor is using the block vector from the ranked list of block vectors.

Example 37. The apparatus according to example 28, wherein the means are further configured for determining a list of valid block vectors for the current block by extracting information from the at least one different block.

Example 38. The apparatus according to example 37, wherein determining the list of valid block vectors comprises testing block vectors in the list for validity, where all non-valid block vectors are removed from the list.

Example 39. An apparatus, comprising means for: performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

Example 40. The apparatus according to example 39, wherein sizes of the sub-templates depend on the size of the template.

Example 41. The apparatus according to example 39, wherein a set of reference samples used to compute the samples in a sub-template comprises already reconstructed samples adjacent to the sub-template, immediately above and immediately on a left edge of the sub-template.

Example 42. The apparatus according to any of examples 22 to 41, wherein the means are further configured for performing one of the following: the producing the intra-prediction for the current block based on the intra-prediction process is performed as part of an encoding process to encode the video into a bitstream, and the means are further configured for: forming the bitstream based at least on the intra-prediction process, and outputting the bitstream; or the producing the intra-prediction for the current block based on the intra-prediction process is performed as part of a decoding process to decode the video that has been encoding into a bitstream, and the means are further configured for: forming an output video based at least on the intra-prediction process, and outputting the output video.

Example 43. An apparatus, comprising: one or more processors; and one or more memories storing instructions that, when executed by the one or more processors, cause the apparatus at least to perform: performing a process for a video having a frame split into blocks, comprising producing an intra-prediction for a current block based on an intra-prediction process, where the intra-prediction process comprises: computing two or more predictors for the current block based on two or more intra-prediction modes; and blending the two or more predictors to form the intra-prediction for the current block using blending weights assigned to the two or more predictors, where the intra-prediction modes are extracted from at least one different block predicted by using a template-based intra mode derivation, where the intra-prediction modes are determined based on computing distortions in a first template adjacent one or more edges of the at least one different block, where the blending weights assigned to the two or more predictors are determined based on computing distortions in a second template adjacent one or more edges of the current block.

Example 44. The apparatus according to example 43, wherein the one or more memories further store instructions that, when executed by the one or more processors, cause the apparatus at least to perform: computing a template distortion for each of the two or more intra-prediction modes, where each intra-prediction mode is used to predict already reconstructed samples in the second template that is adjacent the one or more edges of the current block; and assigning individual ones of the blending weights to individual ones of the predictors based on the computed template distortions.

Example 45. The apparatus according to example 44, wherein a highest blending weight among the blending weights assigned to the predictors is assigned to a predictor obtained with an intra-prediction mode resulting in a lowest distortion among the distortions computed on the second template using the two or more intra-prediction modes extracted from the at least one different block.

Example 46. The apparatus according to example 44, wherein a lowest blending weight among the blending weights assigned to the predictors is assigned to a predictor obtained with the intra-prediction mode resulting in a highest distortion among the distortions computed on the second template using the two or more intra-prediction modes extracted from thee at least one different block.

Example 47. The apparatus according to example 43, wherein the one or more memories further store instructions that, when executed by the one or more processors, cause the apparatus at least to perform selecting one or more blending weights to use between weights determined based on computing distortions in the second template and weights extracted from the at least one different block predicted by using a template-based intra mode derivation, where the weights are determined based on computing distortions in the first template.

Example 48. The apparatus according to example 43, wherein: a first set of blending weights are determined based on computed distortions in the first template adjacent the one or more edges of the at least one different block; a second set of blending weights are determined based on computed distortions in the second template adjacent the one or more edges of the current block; a first cost is determined based on the first set of blending weights and the computed distortions in the second template; a second cost is determined based on the second set of blending weights and the computed distortions in the second template; and the blending weights to form the intra-prediction for the current block are selected between the first set or second set based on the first and second costs.

Example 49. An apparatus, comprising: one or more processors; and one or more memories storing instructions that, when executed by the one or more processors, cause the apparatus at least to perform: performing a process for a video having a frame split into blocks, comprising producing an intra-prediction for a current block based on an intra-prediction process, where the intra-prediction process comprises: computing one or more predictors for the current block based on intra-prediction modes; and blending the one or more predictors to form the intra-prediction for the current block, where the intra-prediction modes are extracted from at least one different block predicted by using at least a template-based intra mode derivation, where the intra-prediction modes are determined based on computing distortions in a template surrounding the at least one different block, where at least one of the one or more predictors is predicted by extracting reconstructed samples from the frame by using at least a block vector pointing to a specific region in the frame.

Example 50. The apparatus according to example 49, where template-based intra mode derivation information is extracted from the at least one different block, and comprises one or more of the intra-prediction modes with corresponding blending weights.

Example 51. The apparatus according to example 50, wherein the extracted template-based intra mode derivation information indicates that at least one of the intra-prediction modes is a block-vector-based intra-prediction mode.

Example 52. The apparatus according to example 51, wherein the extracted template-based intra mode derivation information includes at least one block vector extracted from the at least one different block.

Example 53. The apparatus according to example 52, wherein the one or more memories further store instructions that, when executed by the one or more processors, cause the apparatus at least to perform determining whether the extracted block vector is valid for the current block, where the extracted block vector is determined to be valid depending on an area that the extracted block vector refers to and availability of the samples in that area.

Example 54. The apparatus according to example 53, wherein, when the extracted block vector is determined to be not valid for the current block, the block-vector-based intra-prediction mode is replaced with a pre-determined intra-prediction mode.

Example 55. The apparatus according to example 53, wherein when the extracted block vector is determined to be not valid for the current block, another block vector that is valid for the current block is used for block vector-based predictor generation.

Example 56. The apparatus according to example 51, wherein: when the template-based intra mode derivation information is extracted from the at least one different block that indicates usage of a block vector-based predictor, generating a list of potential valid block vectors for the current block by extracting block vector information from previously coded blocks that utilized at least one block vector in prediction; and generating at least one new candidate for a merge list, where block vector-based predictor is using the block vector from the generated list of potential valid block vectors.

Example 57. The apparatus according to example 51, wherein: when the template-based intra mode derivation information is extracted from the at least one different block that indicates usage of block vector-based predictor, generating a list of potential valid block vectors for the current block by extracting block vector information from previously coded blocks that utilized at least one block vector in prediction; ranking the list of potential valid block vectors based on their distortions calculated over corresponding templates for blocks pointed to by the potential valid block vectors and the template for the current block; and generating at least one new candidate for a merge list where block vector-based predictor is using the block vector from the ranked list of block vectors.

Example 58. The apparatus according to example 49, wherein the one or more memories further store instructions that, when executed by the one or more processors, cause the apparatus at least to perform determining a list of valid block vectors for the current block by extracting information from the at least one different block.

Example 59. The apparatus according to example 58, wherein determining the list of valid block vectors comprises testing block vectors in the list for validity, where all non-valid block vectors are removed from the list.

Example 60. An apparatus, comprising: one or more processors; and one or more memories storing instructions that, when executed by the one or more processors, cause the apparatus at least to perform: performing a process for a video having a frame split into blocks, comprising producing an intra-prediction for a current block based on an intra-prediction process, where the intra-prediction process comprises: computing one or more predictors for the current block based on intra-prediction modes; and blending the predictors to form the intra-prediction for the current block, where the intra-prediction modes are computed by using at least a template-based intra mode derivation, where the intra-prediction modes are determined based on computing distortions in a template surrounding one or more edges of the current block, where the distortions are computed based on computing a prediction of samples in the template, where the template is partitioned into a number of sub-templates, where samples in each sub-template are predicted using a different set of reference samples, and where a distortion is computed for a current template by combining the distortions obtained in each sub-template of the template.

Example 61. The apparatus according to example 60, wherein sizes of the sub-templates depend on the size of the template.

Example 62. The apparatus according to example 60, wherein a set of reference samples used to compute the samples in a sub-template comprises already reconstructed samples adjacent to the sub-template, immediately above and immediately on a left edge of the sub-template.

Example 63. The apparatus according to any of examples 43 to 62, wherein the one or more memories further store instructions that, when executed by the one or more processors, cause the apparatus at least to perform performing one of the following: the producing the intra-prediction for the current block based on the intra-prediction process is performed as part of an encoding process to encode the video into a bitstream, and the one or more memories further store instructions that, when executed by the one or more processors, cause the apparatus at least to perform: forming the bitstream based at least on the intra-prediction process, and outputting the bitstream; or the producing the intra-prediction for the current block based on the intra-prediction process is performed as part of a decoding process to decode the video that has been encoding into a bitstream, and the one or more memories further store instructions that, when executed by the one or more processors, cause the apparatus at least to perform: forming an output video based at least on the intra-prediction process, and outputting the output video.

Example 64. A computer program, comprising instructions which, when the program is executed by an apparatus, cause the apparatus to carry out the methods of any of examples 1 to 21.

Example 65. The computer program according to example 64, wherein the computer program is a computer program product comprising a computer-readable medium bearing the instructions embodied therein for use with the apparatus.

Example 66. The computer program according to example 64, wherein the computer program is directly loadable into an internal memory of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) (including digital signal processor(s)) with software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 9. A computer-readable medium may comprise a computer-readable storage medium (e.g., memories 952 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
BV block vector
CU coding unit
ECM enhanced compression model
MPM most probable mode
JVET Joint video experts team
SAD sum of absolute differences
SATD sum of absolute transformed differences
TIMD template-based intra mode derivation
VVC versatile video coding

What is claimed is:

1. An apparatus, comprising:
one or more processors; and
one or more memories storing instructions that, when executed by the one or more processors, cause the apparatus at least to perform:
performing a process for a video having a frame split into blocks, comprising producing an intra-prediction for a current block based on an intra-prediction process, where the intra-prediction process comprises:
computing two or more predictors for the current block based on two or more intra-prediction modes; and
blending the two or more predictors to form the intra-prediction for the current block using blending weights assigned to the two or more predictors,
where the intra-prediction modes are extracted from at least one different block predicted by using a template-based intra mode derivation, where the intra-prediction modes are determined based on computing distortions in a first template adjacent one or more edges of the at least one different block,
where the blending weights assigned to the two or more predictors are determined based on computing distortions in a second template adjacent one or more edges of the current block.

2. The apparatus according to claim 1, wherein the one or more memories further store instructions that, when executed by the one or more processors, cause the apparatus at least to perform:
computing a template distortion for each of the two or more intra-prediction modes, where each intra-prediction mode is used to predict already reconstructed samples in the second template that is adjacent the one or more edges of the current block; and
assigning individual ones of the blending weights to individual ones of the predictors based on the computed template distortions.

3. The apparatus according to claim 2, wherein a highest blending weight among the blending weights assigned to the predictors is assigned to a predictor obtained with an intra-prediction mode resulting in a lowest distortion among the distortions computed on the second template using the two or more intra-prediction modes extracted from the at least one different block.

4. The apparatus according to claim 2, wherein a lowest blending weight among the blending weights assigned to the predictors is assigned to a predictor obtained with the intra-prediction mode resulting in a highest distortion among the distortions computed on the second template using the two or more intra-prediction modes extracted from thee at least one different block.

5. The apparatus according to claim 1, wherein the one or more memories further store instructions that, when executed by the one or more processors, cause the apparatus at least to perform: selecting one or more blending weights to use between weights determined based on computing distortions in the second template and weights extracted from the at least one different block predicted by using a template-based intra mode derivation, where the weights are determined based on computing distortions in the first template.

6. The apparatus according to claim 1, wherein:
a first set of blending weights are determined based on computed distortions in the first template adjacent the one or more edges of the at least one different block;
a second set of blending weights are determined based on computed distortions in the second template adjacent the one or more edges of the current block;
a first cost is determined based on the first set of blending weights and the computed distortions in the second template;
a second cost is determined based on the second set of blending weights and the computed distortions in the second template; and
the blending weights to form the intra-prediction for the current block are selected between the first set or second set based on the first and second costs.

7. An apparatus, comprising:
one or more processors; and
one or more memories storing instructions that, when executed by the one or more processors, cause the apparatus at least to perform:
performing a process for a video having a frame split into blocks, comprising producing an intra-prediction for a current block based on an intra-prediction process, where the intra-prediction process comprises:
computing one or more predictors for the current block based on intra-prediction modes; and
blending the one or more predictors to form the intra-prediction for the current block,
where the intra-prediction modes are extracted from at least one different block predicted by using at least a template-based intra mode derivation, where the intra-prediction modes are determined based on computing distortions in a template surrounding the at least one different block,
where at least one of the one or more predictors is predicted by extracting reconstructed samples from the frame by using at least a block vector pointing to a specific region in the frame.

8. The apparatus according to claim 7, where template-based intra mode derivation information is extracted from the at least one different block, and comprises one or more of the intra-prediction modes with corresponding blending weights.

9. The apparatus according to claim 8, wherein the extracted template-based intra mode derivation information indicates that at least one of the intra-prediction modes is a block-vector-based intra-prediction mode.

10. The apparatus according to claim 9, wherein the extracted template-based intra mode derivation information includes at least one block vector extracted from the at least one different block.

11. The apparatus according to claim 10, wherein the one or more memories further store instructions that, when executed by the one or more processors, cause the apparatus at least to perform: determining whether the extracted block vector is valid for the current block, where the extracted block vector is determined to be valid depending on an area that the extracted block vector refers to and availability of the samples in that area.

12. The apparatus according to claim 11, wherein, when the extracted block vector is determined to be not valid for the current block, the block-vector-based intra-prediction mode is replaced with a pre-determined intra-prediction mode.

13. The apparatus according to claim 11, wherein when the extracted block vector is determined to be not valid for the current block, another block vector that is valid for the current block is used for block vector-based predictor generation.

14. The apparatus according to claim 9, wherein:
when the template-based intra mode derivation information is extracted from the at least one different block that indicates usage of a block vector-based predictor, generating a list of potential valid block vectors for the current block by extracting block vector information from previously coded blocks that utilized at least one block vector in prediction; and
generating at least one new candidate for a merge list, where block vector-based predictor is using the block vector from the generated list of potential valid block vectors.

15. The apparatus according to claim 9, wherein:
when the template-based intra mode derivation information is extracted from the at least one different block that indicates usage of block vector-based predictor, generating a list of potential valid block vectors for the current block by extracting block vector information from previously coded blocks that utilized at least one block vector in prediction;
ranking the list of potential valid block vectors based on their distortions calculated over corresponding templates for blocks pointed to by the potential valid block vectors and the template for the current block; and
generating at least one new candidate for a merge list where block vector-based predictor is using the block vector from the ranked list of block vectors.

16. The apparatus according to claim 7, wherein the one or more memories further store instructions that, when executed by the one or more processors, cause the apparatus at least to perform: determining a list of valid block vectors for the current block by extracting information from the at least one different block.

17. The apparatus according to claim 16, wherein determining the list of valid block vectors comprises testing block vectors in the list for validity, where all non-valid block vectors are removed from the list.

18. An apparatus, comprising:
one or more processors; and
one or more memories storing instructions that, when executed by the one or more processors, cause the apparatus at least to perform:
performing a process for a video having a frame split into blocks, comprising producing an intra-prediction for a current block based on an intra-prediction process, where the intra-prediction process comprises:
computing one or more predictors for the current block based on intra-prediction modes; and
blending the predictors to form the intra-prediction for the current block,
where the intra-prediction modes are computed by using at least a template-based intra mode derivation, where the intra-prediction modes are determined based on computing distortions in a template surrounding one or more edges of the current block,
where the distortions are computed based on computing a prediction of samples in the template,
where the template is partitioned into a number of sub-templates, where samples in each sub-template are predicted using a different set of reference samples, and
where a distortion is computed for a current template by combining the distortions obtained in each sub-template of the template.

19. The apparatus according to claim 18, wherein a set of reference samples used to compute the samples in a sub-template comprises already reconstructed samples adjacent to the sub-template, immediately above and immediately on a left edge of the sub-template.

20. The apparatus according to claim 1, wherein the one or more memories further store instructions that, when executed by the one or more processors, cause the apparatus at least to perform: performing one of the following:
the producing the intra-prediction for the current block based on the intra-prediction process is performed as part of an encoding process to encode the video into a bitstream, and the one or more memories further store instructions that, when executed by the one or more processors, cause the apparatus at least to perform: forming the bitstream based at least on the intra-prediction process, and outputting the bitstream; or
the producing the intra-prediction for the current block based on the intra-prediction process is performed as part of a decoding process to decode the video that has been encoding into a bitstream, and the one or more memories further store instructions that, when executed by the one or more processors, cause the apparatus at least to perform: forming an output video based at least on the intra-prediction process, and outputting the output video.
